(19) United States
(12) Patent Application Publication
(10) Pub. No.: US 2013/0290768 A1
(43) Pub. Date: Oct. 31, 2013

(54) ARITHMETIC PROCESSING DEVICE, METHOD FOR CONTROLLING ARITHMETIC PROCESSING DEVICE, AND SYSTEM

(71) Applicant: FUJITSU LIMITED, Kawasaki-shi (JP)

(72) Inventor: Yasuhiro KITAMURA, Kawasaki (JP)

(73) Assignee: FUJITSU LIMITED, Kawasaki-shi (JP)

(21) Appl. No.: 13/850,389

(22) Filed: Mar. 26, 2013

(30) Foreign Application Priority Data
Apr. 25, 2012 (JP) 2012-099753

(51) Int. Cl. G06F 1/08

(52) U.S. Cl. CPC G06F 1/08
USPC 713/503

(57) ABSTRACT

An arithmetic processing device includes: a communicating unit that communicates with another arithmetic processing device; a clock controller that requests a change in the frequency of a clock signal; a sequence controller that instructs the other arithmetic processing device to change the amount of data to be transmitted by the other arithmetic processing device to the arithmetic processing device per unit time when the sequence controller is requested by the clock controller to change the frequency of the clock signal; and a control circuit that changes the amount of data to be transmitted by the communicating unit to the other arithmetic processing device per unit time when the other arithmetic processing device instructs the arithmetic processing device to change the amount of data to be transmitted by the arithmetic processing device to the other arithmetic processing device per unit time.

### CROSS-REFERENCE TO RELATED APPLICATION

This application is based upon and claims the benefit of priority of the prior Japanese Patent Application No. 2012-099753, filed on Apr. 25, 2012, the entire contents of which are incorporated herein by reference.

### FIELD

The embodiment discussed herein is related to an arithmetic processing device, a method for controlling an arithmetic processing device and a system.

### BACKGROUND

As a conventional technique, a data transfer control device that transfers data through a serial Advanced Technology Attachment (ATA) bus is known. Japanese Laid-open Patent Publication No. 2007-233998 is an example of the conventional technique. The data transfer control device includes a transport controller and a link controller. The transport controller receives a second clock generated by a physical layer circuit on the basis of a first clock serving as a standard clock and operates on the basis of the second clock. The link controller receives the first and second clocks and operates on the basis of the first and second clocks. The link controller includes a link state control circuit and a power management control circuit. The link state control circuit operates on the basis of the second clock and controls the state of the link controller. The power management control circuit operates on the basis of the first clock and controls the state of power management.

As another conventional technique, a system controller is known, which is configured by a single chip LSI having a clock control circuit for controlling supply of a CPU clock and an internal clock. Japanese Laid-open Patent Publication No. 10-124169 is an example of the other conventional technique. The system controller includes a clock control unit that controls the frequency of the internal clock in a variable manner in coordination with a change in the frequency of the CPU clock.

As another conventional technique, the following technique is known: a technique for causing at least one of two network devices opposing each other to transmit and receive three types of flow control frames that are a data frame, a training frame, and a pause frame or a similar frame to the pause frame. Japanese Laid-open Patent Publication No. 2005-217503 is an example of the other conventional technique. When a flow control frame is detected from output of a receiver, a first instruction to reduce the frequency of a clock to be transmitted from a transmitter is generated. When a flow control frame is detected from output of the transmitter, a second instruction to increase the frequency of the clock to be transmitted from the transmitter is generated. A new set value for the frequency of the clock to be transmitted is determined on the basis of a set convergence algorithm by referencing the latest set value for the frequency of the clock to be transmitted in accordance with the first and second instructions.

### SUMMARY

According to an aspect of the invention, an arithmetic processing device includes: a communicating unit that communicates with another arithmetic processing device; a clock controller that requests a change in the frequency of a clock signal; a sequence controller that instructs the other arithmetic processing device to change the amount of data to be transmitted by the other arithmetic processing device to the arithmetic processing device per unit time when the sequence controller is requested by the clock controller to change the frequency of the clock signal; and a control circuit that changes the amount of data to be transmitted by the communicating unit to the other arithmetic processing device per unit time when the other arithmetic processing device instructs the arithmetic processing device to change the amount of data to be transmitted by the arithmetic processing device to the other arithmetic processing device per unit time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of the configuration of an arithmetic processing system according to an embodiment;

FIG. 1B is a diagram illustrating an example of the configuration of a first central processing unit;

FIGS. 2A and 2B are diagrams illustrating examples of processes that are executed by the first central processing unit and a second central processing unit in order to change the frequency of a clock signal;

FIG. 3 is a diagram illustrating an example of a detailed configuration of a part of the first central processing unit;

FIG. 4 is a diagram illustrating an example of the configuration of a throughput limiting unit illustrated in FIG. 3;

FIG. 5 is a diagram illustrating an example of the format of a packet;

FIG. 6 is a diagram illustrating an example of a table that stores relationships between frequencies and the numbers of invalid data items;

FIG. 7 is a flowchart of an example of a process to be executed by a control method in order to reduce the frequency of a clock signal for a core of the first central processing unit;

FIG. 8 is a flowchart of an example of a process to be executed by the control method in order to increase the frequency of the clock signal for the core of the first central processing unit; and

FIG. 9 is a flowchart of another example of the process to be executed by the control method to be executed in order to increase the frequency of the clock signal for the core of the first central processing unit.

### DESCRIPTION OF EMBODIMENT

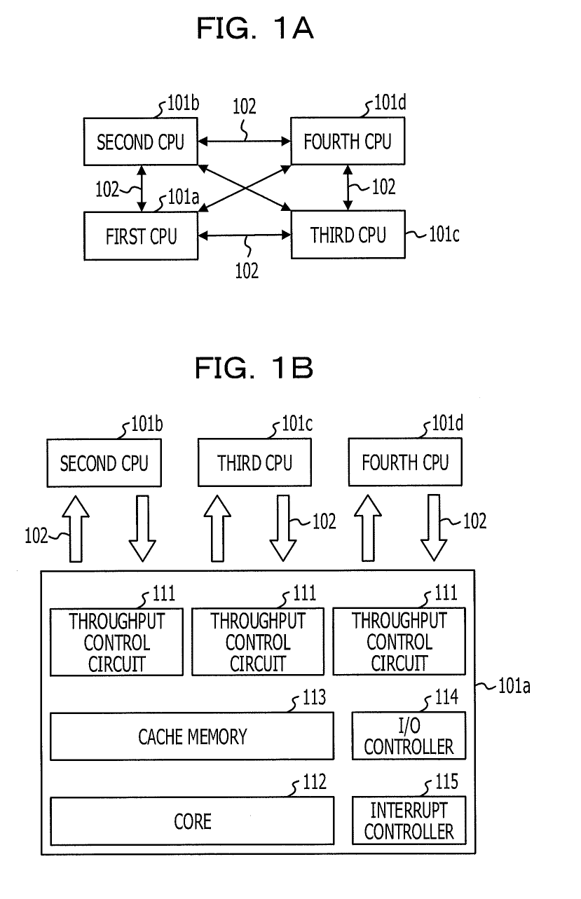

FIG. 1A is a diagram illustrating an example of the configuration of an arithmetic processing system according to an embodiment. The arithmetic processing system is, for example, a server or a supercomputer and includes a first central processing unit (CPU) 101a, a second central processing unit 101b, a third central processing unit 101c, and a fourth central processing unit 101d. The first central processing unit 101a to the fourth central processing unit 101d are coupled to each other by a bus 102 and communicate each other.

FIG. 1B is a diagram illustrating an example of the configuration of the first central processing unit 101a. Hereinafter, the configuration of the first central processing unit 101a is described as an example. The configurations of the second to fourth central processing unit 101b to 101d are the same as the configuration of the first central processing unit 101a. The first central processing unit 101a has three throughput control circuits 111, a core 112 a cache memory 113, an input and output controller (I/O controller) 114, and an interrupt controller 115. The three throughput control circuits 111 may transmit and receive data to and from the second to fourth central processing units 101b to 101d through the bus 102. The throughput control circuits 111 may control throughput of transmission from the first central processing unit 101a to the second to fourth central processing units 101b to 101d. The throughput is the amount of data to be transmitted through the bus 102 per unit time.

When determining that a task to be assigned to the core 112 does not exist or the number of tasks to be assigned to the core 112 is small, the first central processing unit 101a may reduce an operational frequency of the core 112 and thereby reduce power to be consumed. A resource may be efficiently used by causing the second to fourth central processing units 101b to 101d to use surplus power. If the operational frequency is dynamically reduced, the throughput of the first central processing unit 101a is reduced. Thus, the amounts of data on the bus 102 are controlled. Specifically, the first central processing unit 101a writes data received from the bus 102 in reception buffers. If the operational frequency is reduced, the rates of reading data from the reception buffers are reduced. Thus, data may overflow from the reception buffers and be lost. To avoid the case, the throughput control circuits 111 control the throughput of the transmission and inhibit data from overflowing from the reception buffers in the embodiment.

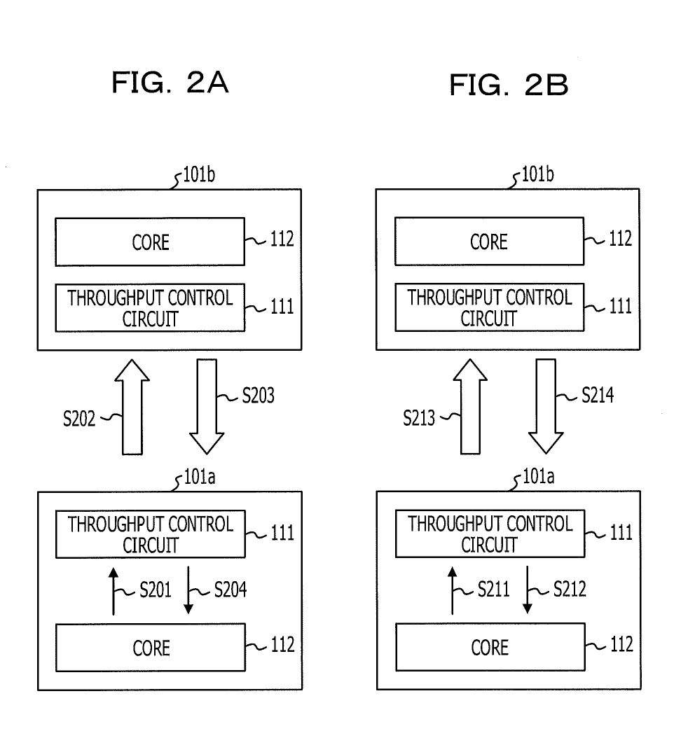

FIG. 2A is a diagram illustrating an example of a process to be executed by the first and second central processing units 101a and 101b in order to reduce the frequency of a clock signal. When determining that a task to be assigned to the core 112 of the first central processing unit 101a does not exist or the number of tasks to be assigned to the core 112 of the first central processing unit 101a is small, the core 112 of the first central processing unit 101a outputs a request S201 to reduce the frequency of the clock signal to a throughput control circuit 111 of the first central processing unit 101a. Then, the throughput control circuit 111 transmits a request S202 to reduce the throughput of transmission to the second central processing unit 101b. When receiving the request S202 to reduce the throughput of the transmission, a throughput control circuit 111 of the second central processing unit 101b reduces the throughput of the transmission from the second central processing unit 101b to the first central processing unit 101a and transmits, to the first central processing unit 101a, a notification S203 indicating completion of the change in the throughput. When receiving the notification S203 indicating the completion of the change in the throughput, the throughput control circuit 111 of the first central processing unit 101a outputs, to the core 112, a notification S204 indicating approval for the change in the frequency in response to the request S201 to reduce the frequency of the clock signal. Then, the core 112 executes control so as to reduce the frequency of the clock signal and reduces the operational frequency. Thus, power to be consumed by the core 112 may be reduced. In addition, overflow from the reception buffer may be inhibited by reducing the throughput of the transmission from the second central processing unit 101b and reducing the frequency of the clock signal of the first central processing unit 101a. The throughput is reduced to throughput based on the frequency of the clock signal.

The first central processing unit 101a transmits the request S202 to reduce the throughput of transmission to the third and fourth central processing units 101c and 101d as well as the second central processing unit 101b. When receiving the request S202 to reduce the throughput, the third and fourth central processing units 101c and 101d reduce the throughput of the transmission from the third and fourth central processing units 101c and 101d to the first central processing unit 101a and transmit, to the first central processing unit 101a, notifications S203 indicating completion of the changes in the throughput. When receiving the notifications S203 indicating the completion of the changes in the throughput from the second to fourth central processing units 101b to 101d, the throughput control circuits 111 of the first central processing unit 101a output, to the core 112, notifications S204 indicating approval for the changes in the throughput in response to the request S201 to reduce the frequency of the clock signal. Then, the core 112 executes control so as to reduce the frequency of the clock signal and reduces the operational frequency. Since the throughput of the transmission from the second to fourth central processing units 101b to 101d to the first central processing unit 101a is reduced in the aforementioned manner, overflow from the reception buffers of the first central processing unit 101a may be inhibited.

FIG. 2B is a diagram illustrating an example of a process to be executed by the first and second central processing units 101a and 101b in order to increase the frequency of the clock signal. When determining that the number of tasks to be assigned to the core 112 of the first central processing unit 101a is large, the core 112 of the first central processing unit 101a outputs a request S211 to increase the frequency of the clock signal to the throughput control circuit 111 of the first central processing unit 101a. Then, the throughput control circuit 111 outputs, to the core 112, a notification S212 indicating approval for the change in the frequency in response to the request S211 to increase the frequency of the clock signal. The core 112 executes control so as to increase the frequency of the clock signal, increases the operational frequency, and outputs, to the throughput control circuit 111, a notification indicating completion of the process of increasing the frequency of the clock signal. Then, the throughput control circuit 111 outputs, to the second central processing unit 101b, a request S213 to increase the throughput of the transmission. When receiving the request S213 to increase the throughput of the transmission, the throughput control circuit 111 of the second central processing unit 101b increases the throughput of the transmission from the second central processing unit 101b to the first central processing unit 101a, and transmits a notification S214 indicating completion of the change in the throughput to the first central processing unit 101a. Thus, the operation speed of the core 112 may be increased by increasing the frequency of the clock signal in the aforementioned manner. When the request S211 to increase the frequency of the clock signal is input to the throughput control circuit 111, the frequency of the clock signal is increased, the throughput of the transmission is increased, and whereby overflow from the reception buffer may be inhibited. The throughput may be increased to throughput based on the frequency of the clock signal by increasing the throughput.

The first central processing unit 101a transmits the request S213 to increase the throughput of transmission to the third and fourth central processing units 101c and 101d as well as the second central processing unit 101b. When receiving the request S213 to increase the throughput, the third and fourth central processing units 101c and 101d increase the throughput of the transmission from the third and fourth central processing units 101c and 101d to the first central processing unit 101a and transmit the notifications 5214 indicating completion of the changes in the throughput to the first central processing unit 101a. In this manner, overflow from the reception buffers of the first central processing unit 101a may be inhibited by increasing the frequency of the clock signal of the first central processing unit 101a and increasing the throughput of the transmission from the second to fourth central processing units 101b to 101d to the first central processing unit 101a.

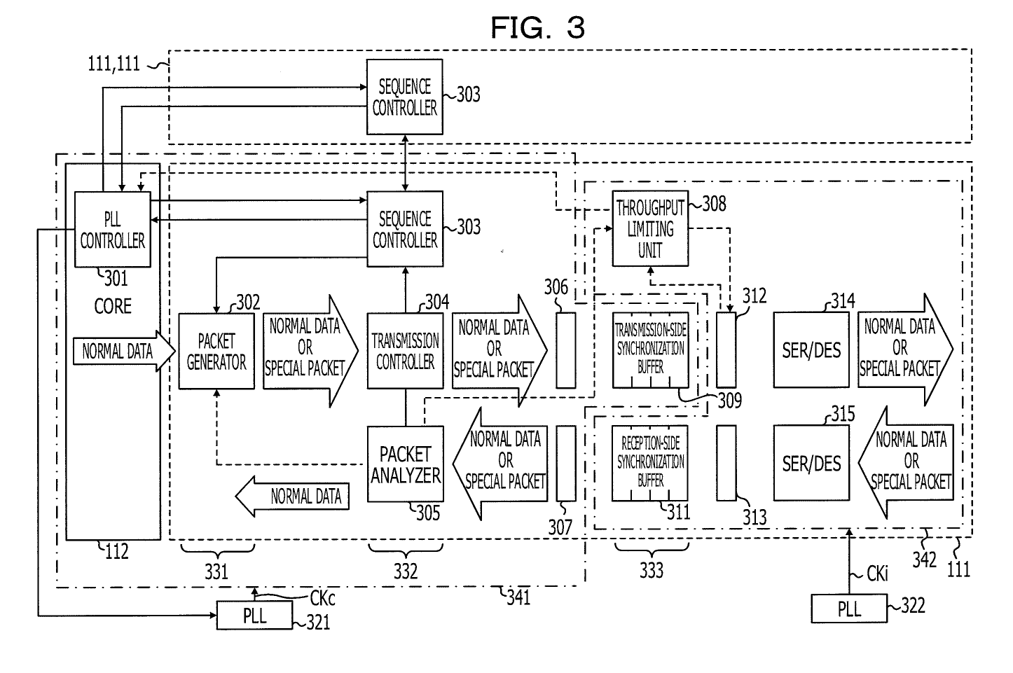

FIG. 3 is a diagram illustrating an example of a detailed configuration of a part of the first central processing unit 101a. Although the configuration of the first central processing unit 101a is described below as an example, the configurations of the second to fourth central processing unit 101b to 101d are the same as the configuration of the first central processing unit 101a. In addition, FIG. 3 illustrates the example of the detailed configuration of a single throughput control circuit 111 among the three throughput control circuits 111. The configurations of the other two throughput control circuits 111 are the same as the throughput control circuit 111 illustrated in FIG. 3. In FIG. 3, solid lines indicate the flow of a process of changing the frequency, while broken lines indicate the flow of a process of changing the throughput of transmission.

The first central processing unit 101a includes the three throughput control circuits 111, the core 112 and two phase locked loop (PLL) circuits 321 and 322.

The phase locked loop circuit 321 generates a clock signal CKc for the core 112 and supplies the clock signal CKc for the core 112 to a block 341. The block 341 includes the core 112 and a part of the throughput control circuit 111 and operates in synchronization with the clock signal CKc for the core 112. A PLL controller (clock controller) 301 that is included in the core 112 may control the frequency of the clock signal CKc generated by the phase locked loop circuit 321. Specifically, if a task to be assigned to the core 112 does not exist or the number of tasks to be assigned to the core 112 is small, the PLL controller 301 may reduce the frequency of the clock signal CKc for the core 112. If the number of tasks to be assigned to the core 112 is large, the PLL controller 301 may increase the frequency of the clock signal CKc for the core 112.

The phase locked loop circuit 322 generates a clock signal CKi for the bus 102 and supplies the clock signal CKi for the bus 102 to a block 342. The block 342 includes the other part of the throughput control circuit 111 and operates in synchronization with the clock signal CKi for the bus 102. The frequency of the clock signal CKi for the bus 102 is a fixed value that is equal to the operational frequency of the bus 102 illustrated in FIGS. 1A and 1B.

The throughput control circuit 111 has a transaction layer 331, a data link layer 332 and a physical layer 333. The transaction layer 331 has a packet generator 302. The data link layer 332 has a sequence controller 303, a transmission controller 304 and a packet analyzer 305. The physical layer 333 has a throughput limiting unit 308, a transmission-side synchronization buffer (transmission buffer) 309 and a reception-side synchronization buffer (reception buffer) 311.

First, a process of transmitting a packet is described below. The core 112 outputs normal data to the packet generator 302. The packet generator 302 generates a packet of the normal data and outputs the generated packet to the transmission controller 304. The transmission controller 304 writes the packet in the transmission-side synchronization buffer (transmission buffer) 309 through a write register 306 in synchronization with the clock signal CKc for the core 112. A serializer/deserializer 314 reads the packet from the transmission-side synchronization buffer 309 through a read register 312 in synchronization with the clock signal CKi for the bus 102. The transmission-side synchronization buffer 309 is a synchronization buffer for transferring a clock signal. The serializer/deserializer 314 converts the packet from parallel data to serial data and transmits the serial data to the bus 102.

Next, a process of receiving a packet is described below. A serializer/deserializer 315 receives a packet from the bus 102 and converts the received packet from serial data to parallel data. The serializers/deserializers 314 and 315 are communicating units that communicate with the other central processing units 101b to 101d. The serializer/deserializer 315 writes the received packet in the reception-side synchronization buffer (reception buffer) 311 through a write register 313 in synchronization with the clock signal CKi for the bus 102. The packet analyzer 305 reads the packet from the reception-side synchronization buffer 311 through a read register 307 in synchronization with the CKc for the core 112, analyzes the read packet, and outputs normal data included in the packet to the core 112. The reception-side synchronization buffer 311 is a synchronization buffer for changing a clock signal to be used. Since the amount of the read data is larger than the amount of the written data, data does not overflow from the reception-side synchronization buffer 311 during a normal operation. If the PLL controller 301 reduces the frequency of the clock signal CKc for the core 112, the amount of the read data is lower than the amount of the written data, and data may overflow from the reception-side synchronization buffer 311. In this case, in order to reduce the amount of data to be written, the throughput of the transmission from the second to fourth central processing units 101b to 101d to the first central processing unit 101a is reduced.

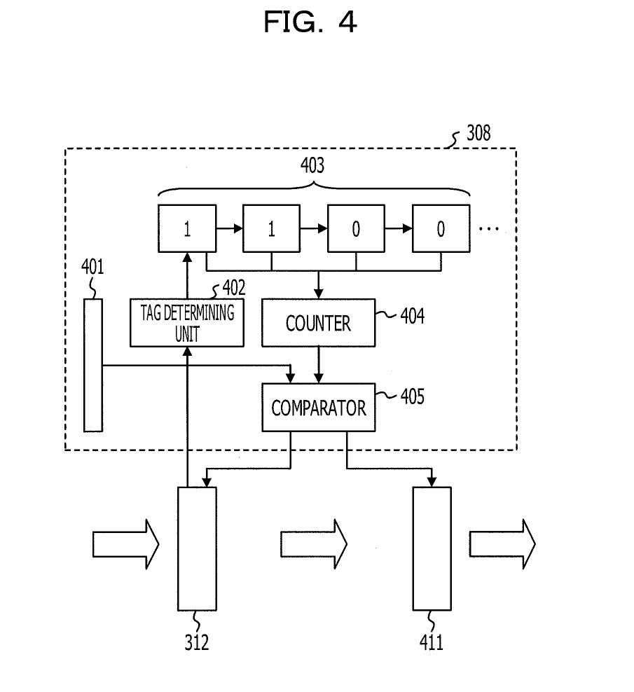

FIG. 4 is a diagram illustrating an example of the configuration of the throughput limiting unit 308 illustrated in FIG. 3. The throughput limiting unit 308 has an invalid data number register 401, a tag determining unit 402, a 20-bit shift register 403, a counter 404, and a comparator 405. A register 411 is included in the serializer/deserializer 314 illustrated in FIG. 3.

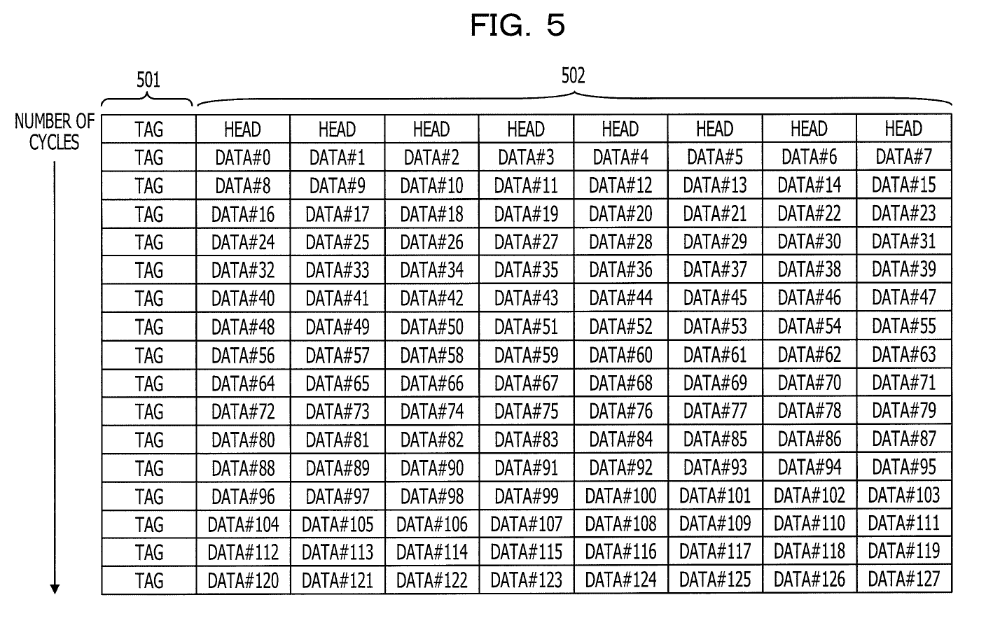

FIG. 5 is a diagram illustrating an example of the format of a packet. The ordinate indicates the number of cycles. The first central processing unit 101a transmits a packet for each of the cycles. FIG. 5 illustrates an example in which 17 packets are transmitted in 17 cycles. The packets each include a 2-bit tag portion 501 and an 8-byte (64-bit) data portion 502. In the 2-bit tag portions 501, “0” indicates an invalid data item, “1” indicates the top packet, “2” indicates packets that are currently transferred, and “3” indicates the last packet. The packets that are currently transferred are packets between the top packet and the last packet. For example, the tag portion 501 of the packet of the first cycle is “1”, the tag portions 501 of the packets of the second to sixteenth cycles are “2”, and the tag portion 501 of the packet of the seventeenth cycle is “3”. The packet that has the tag portion 501 of “0” indicates that the data portion 502 of the packet is the invalid data item. The packets that have the tag portions 501 of “1” to “3” indicate that the data portions 502 of the packets indicate valid data items. If data to be transmitted does not exist, the invalid data item that is indicated by the tag portion 501 of “0” is transmitted. A valid data item or an invalid data item is transmitted in each of the cycles. The data portions 502 each have header information HEAD or a data item DATA. The header information HEAD includes packet type information of a special packet (packet for link control) or a normal data packet. The special packet is a packet to be used to provide an instruction to change the throughput. The normal data packet is a packet of normal data.

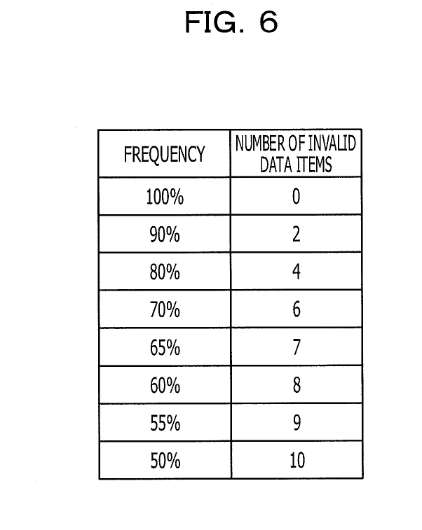

FIG. 6 is a diagram illustrating an example of a table that stores relationships between frequencies and the numbers of invalid data items. The frequencies are the frequencies of the clock signal CKc for the core 112, while the highest frequency of the clock signal CKc for the core 112 is treated as 100%. The numbers of the invalid data items are the numbers of the invalid data items included in packets of the latest 20 cycles. In other words, the numbers of the invalid data items are the numbers of the packets that have the tag portions 501 of “0”. The throughput limiting unit 308 controls the number of invalid data items on the basis of the frequency of the clock signal CKc for the core 112. For example, if the frequency is 100%, the number of invalid data items is 0. If the frequency is 90%, the number of invalid data items is 2. The higher the frequency, the smaller the number of invalid data items. The lower the frequency, the larger the number of invalid data items. The serializer/deserializer 315 receives a valid data item or an invalid data in each of all cycles. If the tag portion 501 of a packet received by the serializer/deserializer 315 from the bus 102 indicates “0”, the tag portion 501 indicates an invalid data item, and the serializer/deserializer 315 does not write the received packet in the reception-side synchronization buffer 311. On the other hand, if the tag portion 501 of the packet received by the serializer/deserializer 315 from the bus 102 indicates “1”, “2” or “3”, the tag portion 501 indicates a valid data item and the serializer/deserializer 315 writes the received packet in the reception-side synchronization buffer 311. For example, if the number of invalid data items among data items of packets received in 20 cycles is small, the number of valid data items is large. Thus, the amount of the data to be written in the reception-side synchronization buffer 311 is large, and data may easily overflow from the reception-side synchronization buffer 311. On the other hand, if the number of invalid data items among the data items packets received in 20 cycles is large, the number of valid data items is small. Thus, the amount of the data to be written in the reception-side synchronization buffer 311 is small, and data may hardly overflow from the reception-side synchronization buffer 311. In order to increase the frequency of the clock signal CKc for the core 112 of the first central processing unit 101a, the throughput of the transmission from the second to fourth central processing units 101b to 101d is increased by reducing the number of invalid data items to be transmitted from the second to fourth central processing units 101b to 101d to the first central processing unit 101a. On the other hand, in order to reduce the frequency of the clock signal CKc for the core 112 of the first central processing unit 101a, the throughput of the transmission from the second to fourth central processing units 101b to 101d is reduced by increasing the number of invalid data items to be transmitted from the second to fourth central processing units 101b to 101d to the first central processing unit 101a. Thus, overflow from the reception-side synchronization buffers 311 of the first central processing unit 101a may be inhibited.

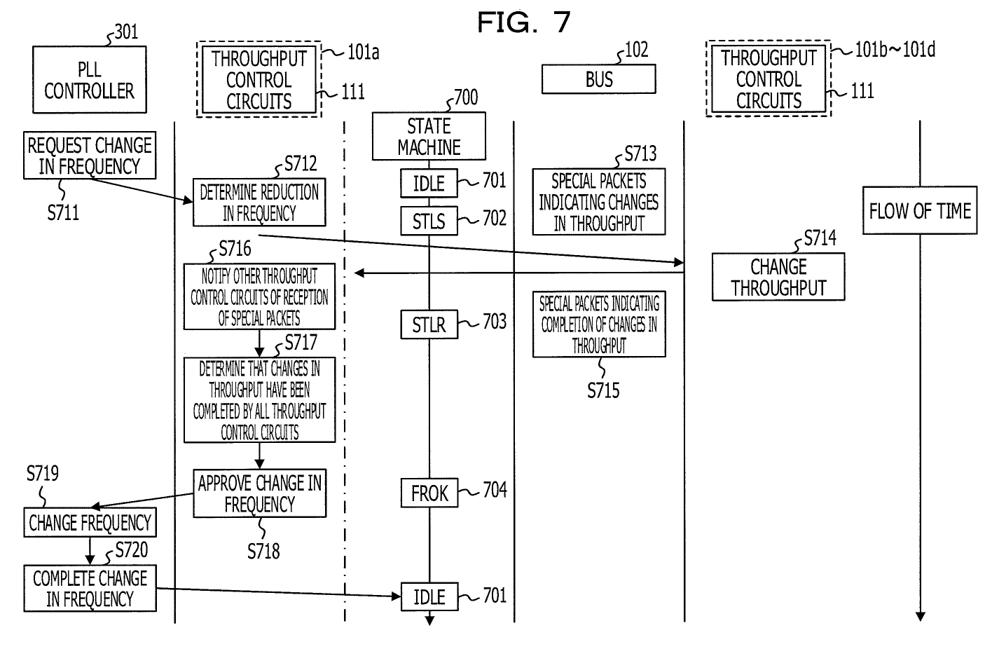

FIG. 7 is a flowchart of an example of a process to be executed by a control method in order to reduce the frequency of the clock signal CKc for the core 112 of the first central processing unit 101a. The PLL controller 301 of the first central processing unit 101a executes processes of steps S711, S719, and S720. The three throughput control circuits 111 of the first central processing unit 101a execute processes of steps S712, S716, S717, and S718. A state machine 700 is a state machine for the sequence controllers 303 of the first central processing unit 101a and controls transition among an IDLE state 701, an STLS state 702, an STLR state 703, and an FROK state 704. The bus 102 executes communication in steps S713 and S715. The throughput control circuits 111 of the second to fourth central processing units 101b to 101d execute a process of step S714.

In an initial state, the state machine 700 is in the IDLE state 701. The IDLE state 701 is a state in which the sequence controllers 303 may receive a frequency change request from the PLL controller 301.

In step S711, the PLL controller 301 of the first central processing unit 101a outputs, to the sequence controllers 303 of the three throughput control circuits 111, a frequency change request to reduce the frequency of the clock signal CKc for the core 112 if a task to be assigned to the core 112 does not exist or the number of tasks to be assigned to the core 112 is small. For example, in order to reduce the frequency of the clock signal CKc for the core 112 from 100% to 90%, the PLL controller 301 outputs a value of 90% as the frequency change request to the sequence controllers 303.

Next, in step S712, the three throughput control circuits 111 of the first central processing unit 101a determine that the received frequency change request is a request to reduce the frequency. Specifically, the three sequence controllers 303 may hold the current frequency of the clock signal CKc for the core 112, compare the current frequency (of, for example, 100%) of the clock signal CKc for the core 112 with the frequency (of, for example, 90%) indicated by the frequency change request, and thereby determine that the received frequency change request is the request to reduce the frequency. Next, the three sequence controllers 303 output frequency change instructions (indicating a frequency of, for example, 90%) to the three packet generators 302, respectively. The frequency change instructions are instructions to change the throughput of the transmission from the second to fourth central processing units 101b to 101d to the first central processing unit 101a. Thus, the state machine 700 makes transition to the STLS state 702.

Next, the three packet generators 302 generate special packets indicating the frequency change instructions using reception of the frequency change instructions as triggers. The special packets each have header information HEAD indicating packet type information of the special packets and header information HEAD indicating codes of the frequency change instructions and the frequency (of, for example, 90%) of the clock signal CKc for the core 112.

Next, in step S713, the transmission controllers 304 of the three throughput control circuits 111 transmit the special packets generated by the three packet generators 302 to the throughput control circuits 111 of the second to fourth central processing units 101b to 101d through the transmission-side synchronization buffers 309, the serializers/deserializers 314 and the bus 102.

Next, in step S714, the packet analyzers 305 of the second to fourth central processing units 101b to 101d receive the special packets from the first central processing unit 101a through the bus 102, the serializers/deserializers 315 and the reception-side synchronization buffers 311.

Processes to be executed by the second to fourth central processing units 101b to 101d are described below. When the header information HEAD of the received packets indicates the special packets, the packet analyzers 305 of the second to fourth central processing units 101b to 101d output the frequency change instructions (indicating the frequency of, for example, 90%) to the throughput limiting units 308 and the packet generators 302.

As illustrated in FIG. 4, when receiving the frequency change instructions, the throughput limiting units 308 reference the table illustrated in FIG. 6, write, in the invalid data number registers 401, the number of invalid data items that corresponds to the frequency (of, for example, 90%) of the clock signal CKc for the core 112 of the frequency change instructions, and output notifications indicating completion of the process of changing the frequency (to a frequency of, for example, 90%) to the PLL controllers 301. Thus, the cores 112 of the second to fourth central processing units 101b to 101d may detect the frequency of the clock signal CKc for the core 112 of the first central processing unit 101a, reconfigure tasks to be assigned to the cores 112, and efficiently execute processes such as processes of reducing the amounts of valid data to be transmitted to the first central processing unit 101a or processes of increasing the amounts of valid data to be transmitted to the first central processing unit 101a.

Next, an example of a process to be executed by the throughput limiting unit 308 illustrated in FIG. 4 is described. As described above, the number (for example, 2) of invalid data items that corresponds to the frequency (of, for example, 90%) is stored in the invalid data number register 401. A packet that is read from the transmission-side synchronization buffer 309 and to be transmitted is stored in the read register 312 for each of cycles. If the tag portion 501 of a packet stored in the read register 312 indicates “0”, the tag portion 501 indicates an invalid data item, and the tag determining unit 402 shifts data of the 20-bit shift register 403 to the right and writes data of “1” in the top portion of the 20-bit shift register 403. If the tag portion 501 of the packet stored in the read register 312 indicates “1”, “2”, or “3”, the tag portion 501 indicates a valid data item, and the tag determining unit 402 shifts data of the 20-bit shift register 403 to the right and writes data of “0” in the top portion of the 20-bit shift register 403. By repeating this process for each of the cycles, information that identifies a valid or invalid data item of each of the latest 20 packets may be stored in the 20-bit shift register 403. The counter 404 counts the number of data items that indicate “1” and have been stored in the 20-bit shift register 403. The comparator 405 compares the value counted by the counter 404 with the number of invalid data items that has been stored in the invalid data number register 401. If the value counted by the counter 404 is smaller than the number of the invalid data items that has been stored in the invalid data number register 401, the throughput of the transmission is too large and the throughput limiting unit 308 stops rewriting in the read register 312 and outputs an instruction to insert an invalid data item to the register 411. Then, a packet that has an invalid data item indicated by the tag portion 501 of “0” is generated and stored in the register 411. In addition, the tag determining unit 402 shifts data stored in the 20-bit shift register 403 to the right and writes data of “1” indicating an invalid data item in the top portion of the 20-bit shift register 403. On the other hand, if the value counted by the counter 404 is equal to or larger than the number of the invalid data items that has been stored in the invalid data number register 401, desired transmission throughput is achieved, and the comparator 405 does not control the read register 312 and the register 411. Thus, invalid data packets of invalid data items of which the number is stored in the invalid data number register 401 may be included in the latest 20 packets. The through put limiting unit 308 may change the throughput of the transmission by changing the ratio of the number of invalid data items to the number of valid data items to be transmitted. Thus, the throughput of the transmission from the second to fourth central processing units 101b to 101d to the first central processing unit 101a may be reduced, and whereby overflow from the reception-side synchronization buffers 311 of the first central processing unit 101a may be inhibited.

When receiving the frequency change instructions of the special packets from the packet analyzers 305, the packet generators 302 generate special packets indicating completion of changes in the throughput as described above.

Next, in step S715, the transmission controllers 304 of the second to fourth central processing units 101b to 101d transmit the special packets generated by the packet generators 302 to the three throughput control circuits 111 of the first central processing unit 101a through the transmission-side synchronization buffers 309, the serializers/deserializers 314, and the bus 102, respectively.

Next, the three throughput control circuits 111 of the first central processing unit 101a receive the special packets indicating the completion of the changes in the throughput from the second to fourth central processing units 101b to 101d. A process to be executed by the first central processing unit 101a is described below. When receiving the special packets indicating the completion of the changes in the throughput from the second to fourth central processing units 101b to 101d, the three packet analyzers 305 of the first central processing unit 101a output notifications indicating the completion of the changes in the throughput to the three sequence controllers 303.

Next, in step S716, when receiving the notifications indicating the completion of the changes in the throughput, each of the three sequence controllers 303 outputs the interested notification indicating the completion of the change in the throughput to the other two sequence controllers 303. Thus, the state machine 700 makes transition to the STLR state 703.

Next, in step S717, when receiving the notifications indicating the completion of the changes in the throughput from the packet analyzers 305 and receiving the notification indicating the completion of the changes in the throughput from the other two sequence controllers 303, each of the sequence controllers 303 determines that the changes in the throughput have been completed by the second to fourth central processing units 101b to 101d. Thus, the state machine 700 makes transition to the FROK state 704.

Next, in step S718, the sequence controllers 303 output, to the PLL controller 301, notifications indicating approval for the change in the frequency in response to the frequency change request output in step S711. Thus, the state machine 700 makes transition to the IDLE state 701.

Next, in step S719, the PLL controller 301 of the first central processing unit 101a outputs, to the phase locked loop circuit 321, an instruction (indicating a frequency of, for example, 90%) to change the frequency of the clock signal CKc for the core 112.

Next, in step S720, the phase locked loop circuit 321 generates a clock signal CKc having the frequency (of, for example, 90%) indicated by the frequency change instruction for the core 112 and outputs the generated clock signal CKc for the core 112 to the block 341. Then, the process of reducing the frequency of the clock signal CKc for the core 112 is completed.

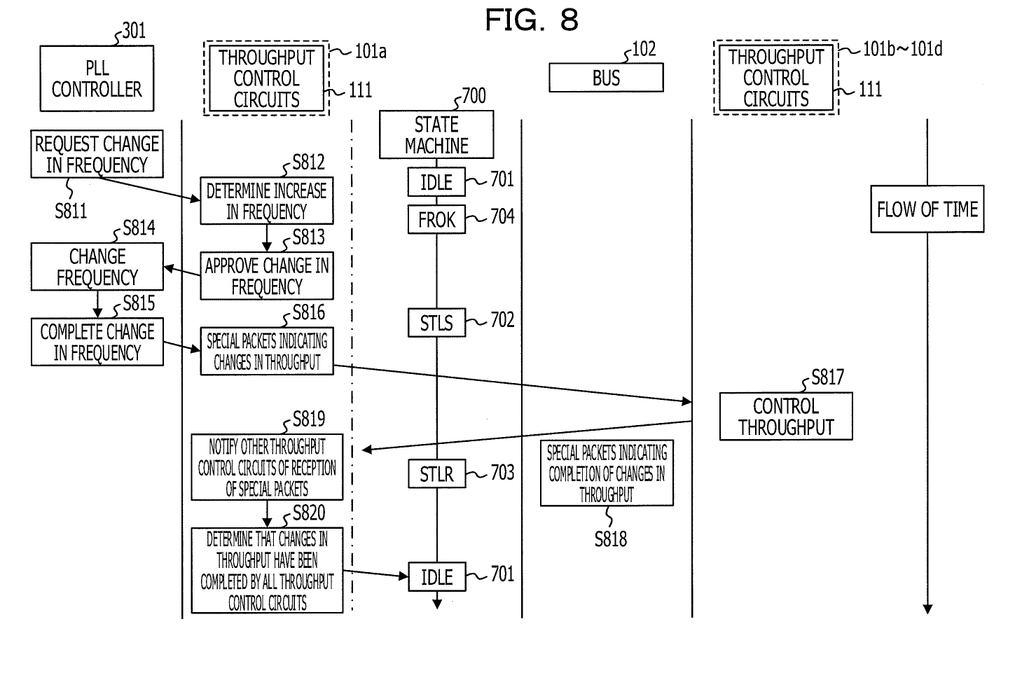

FIG. 8 is a flowchart of an example of a process to be executed by the control method in order to increase the frequency of the clock signal CKc for the core 112 of the first central processing unit 101a. The PLL controller 301 of the first central processing unit 101a executes processes of steps S811, S814, and S815. The three throughput control circuits 111 of the first central processing unit 101a execute processes of steps S812, S813, S816, S819, and S820. The state machine 700 is a state machine for the sequence controllers 303 of the first central processing unit 101a and controls transition among the IDLE state 701, the STLS state 702, the STLR state 703, and the FROK state 704. The bus 102 executes communication in step 818. The throughput control circuits 111 of the second to fourth central processing units 101b to 101d execute a process of step S817.

In an initial state, the state machine 700 is in the IDLE state 701. The IDLE state 701 is a state in which the sequence controllers 303 may receive a frequency change request from the PLL controller 301.

First, in step S811, if the number of tasks to be assigned to the core 112 is large, the PLL controller 301 of the first central processing unit 101a outputs, to the sequence controllers 303 of the three throughput control circuits 111, a frequency change request to increase the frequency of the clock signal CKc for the core 112. For example, in order to increase the frequency of the clock signal CKc for the core 112 from 90% to 100%, the PLL controller 301 outputs a value of 100% as the frequency change request to the sequence controllers 303.

Next, in step S812, the three throughput control circuits 111 of the first central processing unit 101a determine that the received frequency change request is a request to increase the frequency. Specifically, the three sequence controllers 303 may hold the current frequency of the clock signal CKc for the core 112, compare the current frequency (of, for example, 90%) of the clock signal CKc for the core 112 with the frequency (of, for example, 100%) indicated by the frequency change request, thereby determine that the received frequency change request is the request to increase the frequency. Thus, the state machine 700 makes transition to the FROK state 704.

Next, in step S813, the sequence controllers 303 output, to the PLL controller 301, notifications indicating approval for the change in the frequency in response to the frequency change request output in step S811.

Next, in step S814, the PLL controller 301 of the first central processing unit 101a outputs, to the phase locked loop circuit 321, an instruction (indicating a frequency of, for example, 100%) to change the frequency of the clock signal CKc for the core 112 and outputs a notification indicating completion of the change in the frequency to the three sequence controllers 303.

Next, in step S815, the phase locked loop circuit 321 generates a clock signal CKc having the frequency (of, for example, 100%) indicated by the frequency change instruction for the core 112 and outputs the generated clock signal CKc for the core 112 to the block 341. The process of increasing the frequency of the clock signal CKc for the core 112 is completed.

Next, when receiving the notification indicating the completion of the change in the frequency from the PLL controller 301, the three sequence controllers 303 output the frequency change instructions (indicating the frequency of, for example, 100%) to the three packet generators 302, respectively. Thus, the state machine 700 makes transition to the STLS state 702.

Next, the three packet generators 302 generate special packets indicating the frequency change instructions using reception of the frequency change instructions as triggers. In the special packets, header information HEAD has packet type information of the special packets and other header information HEAD has a code of the frequency change instruction and information of the frequency (of, for example, 100%) of the clock signal CKc for the core 112.

Next, in step S816, the transmission controllers 304 of the three throughput control circuits 111 transmit the special packets generated by the three packet generators 302 to the throughput control circuits 111 of the second to fourth central processing units 101b to 101d through the transmission-side synchronization buffers 309, the serializers/deserializers 314, and the bus 102.

Next, in step S817, the packet analyzers 305 of the second to fourth central processing units 101b to 101d receive the special packets from the first central processing unit 101a through the bus 102, the serializers/deserializers 315, and the reception-side synchronization buffers 311.

Processes to be executed by the second to fourth central processing units 101b to 101d are described below. When the header information HEAD of the received packets indicates the special packets, the packet analyzers 305 of the second to fourth central processing units 101b to 101d output the frequency change instructions (indicating the frequency of, for example, 100%) to the throughput limiting units 308 and the packet generators 302.

Next, an example of a process to be executed by the throughput limiting unit 308 illustrated in FIG. 4 is described. As described above, the number (for example, 0) of invalid data items that corresponds to the frequency (of, for example, 100%) is stored in the invalid data number register 401. The throughput limiting unit 308 executes the same process as described with reference to FIG. 7. If the frequency of the clock signal CKc for the core 112 is to be increased, data does not overflow from the reception-side synchronization buffers 311 of the first central processing unit 101a. Thus, by executing the aforementioned process, the throughput of the transmission from the second to fourth central processing units 101b to 101d to the first central processing unit 101a may be increased, and the performance may be improved.

When receiving the frequency change instructions of the special packets from the packet analyzers 305, the packet generators 302 generate special packets indicating completion of the changes in the throughput as described above.

Next, in step S818, the transmission controllers 304 of the second to fourth central processing units 101b to 101d transmit the special packets generated by the packet generators 302 to the three throughput control circuits 111 of the first central processing unit 101a through the transmission-side synchronization buffers 309, the serializers/deserializers 314, and the bus 102.

Next, the three throughput control circuits 111 of the first central processing unit 101a receive the special packets indicating the completion of the changes in the throughput from the second to fourth central processing units 101b to 101d. A process to be executed by the first central processing unit 101a is described below. When receiving the special packets indicating the completion of the changes in the throughput from the second to fourth central processing units 101b to 101d, the three packet analyzers 305 of the first central processing unit 101a output notifications indicating the completion of the changes in the throughput to the three sequence controllers 303.

Next, in step S819, when receiving the notifications indicating the completion of the changes in the throughput, each of the three sequence controllers 303 outputs the interested notification indicating the change in the throughput to the other two sequence controllers 303. Thus, the state machine 700 makes transition to the STLR state 703.

Next, in step S820, when receiving the notifications indicating the completion of the changes in the throughput from the packet analyzers 305 and receiving the notifications indicating the completion of the changes in the throughput from the other two sequence controllers 303, each of the sequence controllers 303 determines that the changes in the throughput have been completed by the second to fourth central processing units 101b to 101d. Then, the state machine 700 makes transition to the IDLE state 701.

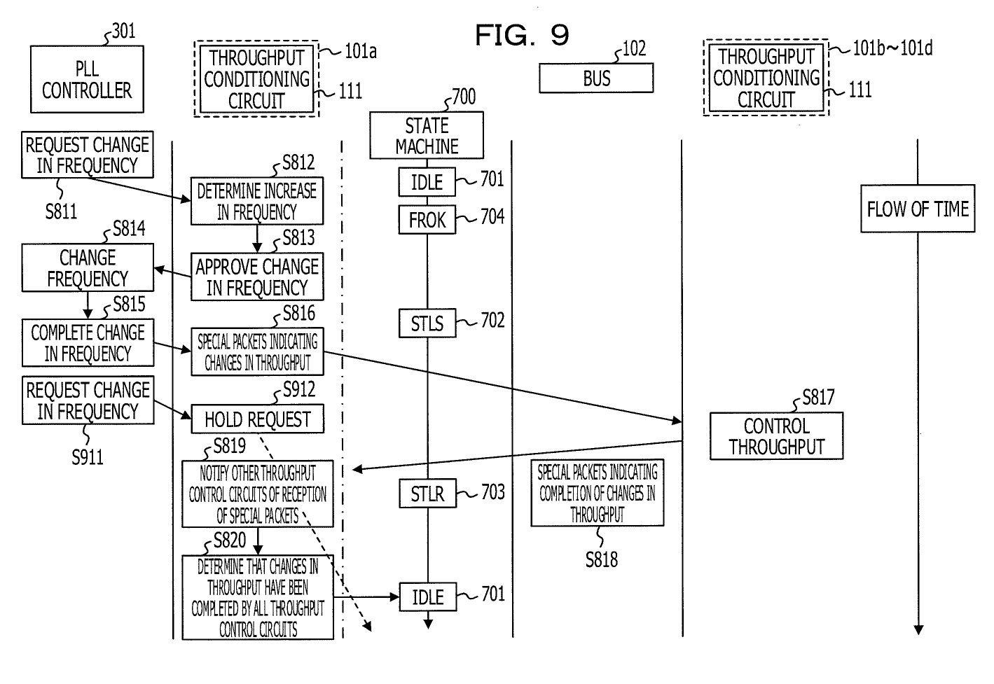

FIG. 9 is a flowchart of another example of the process to be executed by the control method in order to increase the frequency of the clock signal CKc for the core 112 of the first central processing unit 101a. The flowchart of FIG. 9 is obtained by adding steps S911 and S912 to the flowchart of FIG. 8. Differences between the flowchart of FIG. 9 and the flowchart of FIG. 8 are described below. The case where the PLL controller 301 of the first central processing unit 101a outputs the next frequency change request to the sequence controllers 303 included in the three throughput control circuits 111 in step S911 in the middle of the process illustrated in FIG. 8 is described below. In the STLS state 702 for waiting for special packets or the STLR 703, the three sequence controllers 303 hold the received next frequency change request, suspend a process of the next frequency change request, and continue to execute the process (illustrated in FIG. 8) of changing the current frequency. After the process of changing the current frequency is terminated and the process of step S820 is executed, the state machine 700 makes transition to the IDLE state 701. Then, the three sequence controllers 303 start to execute the process illustrated in FIG. 7 or 8 in accordance with the held next frequency change request.

When the PLL controller 301 transmits the next request to change the frequency of the clock signal CKc for the core 112 to the sequence controllers 303 after the sequence controllers 303 instruct the other central processing units 101b to 101d to increase the throughput of the transmission (in S816) and before the sequence controllers 303 receive the notifications indicating the completion of the changes in the throughput from the other central processing units 101b to 101d (in S820), the sequence controllers 303 hold the request and stand by until receiving the notifications indicating the completion of changes in the throughput from the other central processing units 101b to 101d (in S820). After that, the sequence controllers 303 start to execute the process of changing the frequency of the clock signal CKc for the core 112 for the held next request.

The example in which the first central processing unit 101a changes the frequency is described above. The second to fourth central processing units 101b to 101d, however, may change frequencies. Since a throughput control circuit 111 of a transmitting central processing unit and a throughput control circuit 111 of a receiving central processing unit may operate independently of each other, all the first to fourth central processing units 101a to 101d may change the frequencies.

Since the throughput of the transmission from the second to fourth central processing units 101b to 101d is dynamically changed in order to dynamically change the frequency of the first central processing unit 101a for a power-saving function, overflow from the reception-side synchronization buffers 311 of the first central processing unit 101a may be inhibited. Since the first central processing unit 101a that reduces the operational frequency notifies the second to fourth central processing units 101b to 101d of a change in the frequency, resources of the bus may be fully used during the maximum operational frequency and the frequency of the clock signal CKc for the core 112 may be changed to a lower frequency than the frequency of the clock signal CKi for the bus 102. Thus, the frequency may be reduced to a lower frequency than a normal frequency, and a power saving effect is increased. In addition, the implementation cost and a circuit quantity may be reduced, compared with the case where the sizes of the reception-side synchronization buffers 311 are increased and the width of the bus 102 is increased. The arithmetic processing system may continuously operate with only resources (buffers) used for normal operations.

The aforementioned embodiment is only a specific example and may not be interpreted in a limited manner. In other words, various modifications and changes may be added to the embodiment without departing from the technical ideas or main features of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An arithmetic processing device comprising:
a communicating unit that communicates with another arithmetic processing device;
a clock controller that requests a change in the frequency of a clock signal;
a sequence controller that instructs the other arithmetic processing device to change the amount of data to be transmitted by the other arithmetic processing device to the arithmetic processing device per unit time when the sequence controller is requested by the clock controller to change the frequency of the clock signal; and
a control circuit that changes the amount of data to be transmitted by the communicating unit to the other arithmetic processing device per unit time when the other arithmetic processing device instructs the arithmetic processing device to change the amount of data to be transmitted by the arithmetic processing device to the other arithmetic processing device per unit time.

2. The arithmetic processing device according to claim 1,
wherein when the clock controller requests a reduction in the frequency of the clock signal, the sequence controller provides an instruction to reduce the amount of data to be transmitted to the arithmetic processing device per unit time, and when the sequence controller receives, from the other arithmetic processing device, a notification indicating completion of the change in the amount of data to be transmitted to the other arithmetic processing device per unit time, the sequence controller approves the request to reduce the frequency of the clock signal.

3. The arithmetic processing device according to claim 1,
wherein when the clock controller requests an increase in the frequency of the clock signal, the sequence controller approves the request to increase the frequency of the clock signal, and when the sequence controller receives a notification indicating completion of a process of increasing the frequency of the clock signal, the sequence controller provides an instruction to increase the amount of data to be transmitted to the other arithmetic processing device per unit time.

4. The arithmetic processing device according to claim 3,
wherein when the sequence controller is requested by the clock controller to change the frequency of the clock signal for the second time after the sequence controller provides an instruction to increase the amount of data to be transmitted to the other arithmetic processing device per unit time and before the sequence controller receives, from the other arithmetic processing device, a notification indicating completion of the change in the amount of data to be transmitted to the other arithmetic processing device per unit time, the sequence controller holds the request and stands by until receiving, from the other arithmetic processing device, the notification indicating the completion of the change in the amount of data to be transmitted to the other arithmetic processing device per unit time.

5. The arithmetic processing device according to claim 1, further comprising:
a reception buffer in which an invalid data item received from the other arithmetic processing device is not written and a valid data item is written,
wherein the control circuit changes the ratio of the number of invalid data items to the number of valid data items to be transmitted.

6. The arithmetic processing device according to claim 1, wherein the communicating unit is a serializer/deserializer.

7. A method for controlling an arithmetic processing device that includes a communicating unit that communicates with another arithmetic processing device, the method comprising:
requesting a change in the frequency of a clock signal;
instructing the other arithmetic processing device to change the amount of data to be transmitted by the other arithmetic processing device to the arithmetic processing device per unit time when the change in the frequency of the clock signal is requested; and
changing the amount of data to be transmitted by the communicating unit to the other arithmetic processing device per unit time when the other arithmetic processing device instructs the arithmetic processing device to change the amount of data to be transmitted by the arithmetic processing device to the other arithmetic processing device per unit time.

8. The method according to claim 7, further comprising
approving a request to reduce the frequency of the clock signal when the arithmetic processing device receives, from the other arithmetic processing device, a notification indicating completion of the change in the amount of data to be transmitted to the other arithmetic processing device per unit time,
wherein the instructing includes providing an instruction to reduce the amount of data to be transmitted to the other arithmetic processing device per unit time on the basis of the request to reduce the frequency of the clock signal.

9. The method according to claim 7, further comprising
approving a request to increase the frequency of the clock signal,
wherein the instructing includes providing an instruction to increase the amount of data to be transmitted to the other arithmetic processing device per unit time when a notification indicating completion of a process of increasing the frequency of the clock signal is received.

10. The method according to claim 9, further comprising:
holding a request to change the frequency of the clock signal for the second time after an instruction to increase the amount of data to be transmitted to the other arithmetic processing device per unit time is provided and before the arithmetic processing device receives, from the other arithmetic processing device, a notification indicating completion of the change in the amount of data to be transmitted to the other arithmetic processing device per unit time; and
waiting until the arithmetic processing device receives, from the other arithmetic processing device, the notification indicating the completion of the change in the amount of data to be transmitted to the other arithmetic processing device per unit time.

11. The method according to claim 7,
wherein the arithmetic processing device includes a reception buffer in which an invalid data item received from the other arithmetic processing device is not written and a valid data item is written, and
wherein the changing includes changing the ratio of the number of invalid data items to the number of valid data items.

12. A system comprising:
a first arithmetic processing device; and
a second arithmetic processing device,
wherein the first arithmetic processing device includes:
a first communicating unit that communicates with the second arithmetic processing device,
a first clock controller that requests a change in the frequency of a clock signal,
a first sequence controller that instructs the second arithmetic processing device to change the amount of data to be transmitted by the second arithmetic processing device to the first arithmetic processing device per unit time when the first sequence controller is requested by the first clock controller to change the frequency of the clock signal, and
a first control circuit that changes the amount of data to be transmitted by the first communicating unit to the second arithmetic processing device per unit time when the second arithmetic processing device instructs the first arithmetic processing device to change the amount of data to be transmitted by the first arithmetic processing device to the second arithmetic processing device per unit time, and
wherein the second arithmetic processing device includes:
a second communicating unit that communicates with the first arithmetic processing device,
a second clock controller that requests a change in the frequency of a clock signal,
a second sequence controller that instructs the first arithmetic processing device to change the amount of data to be transmitted by the first arithmetic processing device to the second arithmetic processing device per unit time when the second sequence controller is requested by the second clock controller to change the frequency of the clock signal, and
a second control circuit that changes the amount of data to be transmitted by the second communicating unit to the first arithmetic processing device per unit time when the first arithmetic processing device instructs the second arithmetic processing device to change the amount of data to be transmitted by the second arithmetic processing device to the first arithmetic processing device per unit time.

13. The system according to claim 12,
wherein when the first clock controller requests a reduction in the frequency of the clock signal, the first sequence controller provides an instruction to reduce the amount of data to be transmitted to the second arithmetic processing device per unit time, and when the first sequence controller receives, from the second arithmetic processing device, a notification indicating completion of the change in the amount of data to be transmitted to the second arithmetic processing device per unit time, the first sequence controller approves the request to reduce the frequency of the clock signal.

14. The system according to claim 12,
wherein when the first clock controller requests an increase in the frequency of the clock signal, the first sequence controller approves the request to increase the frequency of the clock signal, and when the first sequence controller receives a notification indicating completion of a process of increasing the frequency of the clock signal, the first sequence controller provides an instruction to increase the amount of data to be transmitted to the second arithmetic processing device per unit time.

15. The system according to claim 14,
wherein when the first sequence controller is requested by the first clock controller to change the frequency of the clock signal for the second time after the first sequence controller provides an instruction to increase the amount of data to be transmitted to the second arithmetic processing device per unit time and before the first sequence controller receives, from the second arithmetic processing device, a notification indicating completion of the change in the amount of data to be transmitted to the second arithmetic processing device per unit time, the first sequence controller holds the request and stands by until receiving, from the second arithmetic processing device, the notification indicating the completion of the change in the amount of data to be transmitted to the second arithmetic processing device per unit time.

16. The system according to claim 12, further comprising
a reception buffer in which an invalid data item received from the second arithmetic processing device is not written and a valid data item is written,
wherein the first control circuit changes the ratio of the number of invalid data items to the number of valid data items.
